(19) United States
(12) Patent Application Publication
(10) Pub. No.: US 2026/0341252 A1
(43) Pub. Date: Oct. 29, 2026

(54) STRINGED INSTRUMENT

(71) Applicant: Forte3D, LLC, Ardmore, PA (US)

(72) Inventor: Alfred Goodrich, Ardmore, PA (US)

(73) Assignee: Forte3D, LLC, Ardmore, PA (US)

(21) Appl. No.: 19/106,269

(22) PCT Filed: Aug. 21, 2023
(86) PCT No.: PCT/US2023/072550

§ 371 Date: Feb. 25, 2025

Related U.S. Application Data
(60) Provisional application No. 63/373,767, filed on Aug. 29, 2022.
(60) Provisional application No. 63/385,115, filed on Nov. 28, 2022.
(60) Provisional application No. 63/510,688, filed on Jun. 28, 2023.

(51) Int. Cl. G10D 3/046; G10D 1/02; G10D 3/06

(52) U.S. Cl. CPC G10D 3/046; G10D 1/02; G10D 3/06

(57) ABSTRACT

A musical instrument, such as, without limitation, a violin, viola, cello, or bass, has a curvilinear bottom block within the interior of the instrument having transverse cross-sections that vary from the top rim of the ribs to the back rim of the ribs, for example, in a double hourglass shape. In some embodiments, the instrument has an asymmetric back, an adjustable neck having a threaded wood insert, and/or a two-piece wolf stopper removably connectable to a string of the instrument.

### CROSS-REFERENCE TO RELATED APPLICATIONS

This application claims the benefit of the filing dates of (i) U.S. provisional application No. 63/373,767 (“the '767 provisional”), filed on Aug. 29, 2022 as attorney docket no. 1395.005PROV, (ii) U.S. provisional application No. 63/385,115 (“the '115 provisional”), filed on Nov. 28, 2022 as attorney docket no. 1395.005PROV2, and (iii) U.S. provisional application No. 63/510,688 (“the '688 provisional”), filed on Jun. 28, 2023 as attorney docket no. 1395.005PROV3, the teachings of all of which are incorporated herein by reference in their entirety. The subject matter of this application is also related to the subject matter of U.S. patent application Ser. No. 17/756,743 (“the '743 application”), filed on Jun. 1, 2022 as attorney docket no. 1395.001, the teachings of which are incorporated herein by reference in their entirety.

### BACKGROUND

### Field of the Disclosure

The present disclosure relates to stringed instruments, such as (without limitation) stringed instruments having a soundpost including (without limitation) violins, violas, cellos, and double basses.

### Description of the Related Art

This section introduces aspects that may facilitate a better understanding of the disclosure. The statements of this section are to be read in this light and are not to be understood as admissions about what is prior art or what is not prior art.

FIG. 1A is a front view of a conventional cello 100, FIG. 1B is a side view of the A-string side 104 of the cello 100 of FIG. 1A, and FIG. 1C is a front view of the middle bout of the cello 100 of FIG. 1A. The four strings of the cello 100 are, from left to right in the view of FIG. 1C, the C string, the G string, the D string, and the A string. As such, the left side of the cello 100 in the view of FIGS. 1A and 1B may be referred to as the C-string side 102, for short, while the right side of the cello 100 may be referred to as the A-string side 104, for short. As labeled in FIG. 1B, the cello 100 has an upper bout, a middle bout, and a lower bout.

FIG. 1D is a perspective interior view of a portion of the ribs 106 of the cello 100 of FIGS. 1A-1C showing the bottom block 114 having an endpin hole 116 for receiving the endpin 112 of cello 100 (see FIGS. 1A and 1B). As shown in FIG. 1D, the bottom block 114 has a uniform transverse cross-section from the top rim 118 (where the ribs 106 meet the cello top 108 (see FIGS. 1A and 1B)) to the back rim 120 (where the ribs 106 meet the cello back 110 (see FIG. 1B)).

Conventional stringed instruments, such as violins, violas, cellos, and double basses, all have analogous bottom blocks albeit of different size, but with similarly uniform transverse cross-section from the top rim to the back rim of the ribs.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1A is a front view of a conventional cello, FIG. 1B is a side view of the A-string side of the cello of FIG. 1A, and FIG. 1C is a front view of the middle bout of the cello of FIG. 1A.

FIG. 1D is a perspective interior view of a portion of the ribs of the cello 100 of FIGS. 1A-1C;

FIG. 2A is a perspective view of a portion of the ribs of a cello having a curvilinear bottom block according to one embodiment of the disclosure;

FIG. 2B is a perspective view of the same portion of the ribs as shown in FIG. 2A depicted with the full ellipses that define the partial-elliptical shapes of the transverse cross-sections, respectively, of the bottom block;

FIG. 2C is a plan view of the full ellipse that defines the largest transverse cross-sections at the top and bottom of the bottom block of FIG. 2A;

FIG. 2D is a plan view of the full ellipse that defines the middle transverse cross-section of the bottom block of FIG. 2A;

FIG. 2E is a plan view of the full ellipse that defines the smallest transverse cross-sections of the bottom block of FIG. 2A;

FIG. 3A shows a top-down view of the top of a cello according to certain embodiments of the disclosure;

FIGS. 3B-3D show respective cross-sectional views of the centers of the upper bout (view X-X of FIG. 3A), the middle bout (view Y-Y of FIG. 3A), and the lower bout (view Z-Z of FIG. 3A) of the cello of FIG. 3A;

FIG. 4A is a partial, cross-sectional, side view of a cello of the present disclosure;

FIG. 4B is a partial, cross-sectional, side view of another cello of the present disclosure;

FIG. 4C is a perspective view of the insert 402B of FIG. 4B;

FIG. 5A is perspective view showing a two-piece wolf stopper, according to one embodiment of the disclosure, mounted onto a string of a cello;

FIGS. 5B and 5C are respective perspective views of the base assembly and the cap assembly of the two-piece wolf stopper of FIG. 5A;

FIGS. 5D and 5E are respective perspective views of the base and the cap of the base and cap assemblies of FIGS. 5B and 5C; and

FIG. 5F shows a cross-sectional view of the wolf stopper configured in the tilted configuration of FIG. 5A, with the cello string held in place between the base assembly and the cap assembly.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

### Curvilinear Bottom Block

According to certain embodiments of the present disclosure, stringed instruments, such as violins, violas, cellos, and double basses, have a curvilinear bottom block having transverse cross-sections that vary from the top rim to the back rim of the ribs.

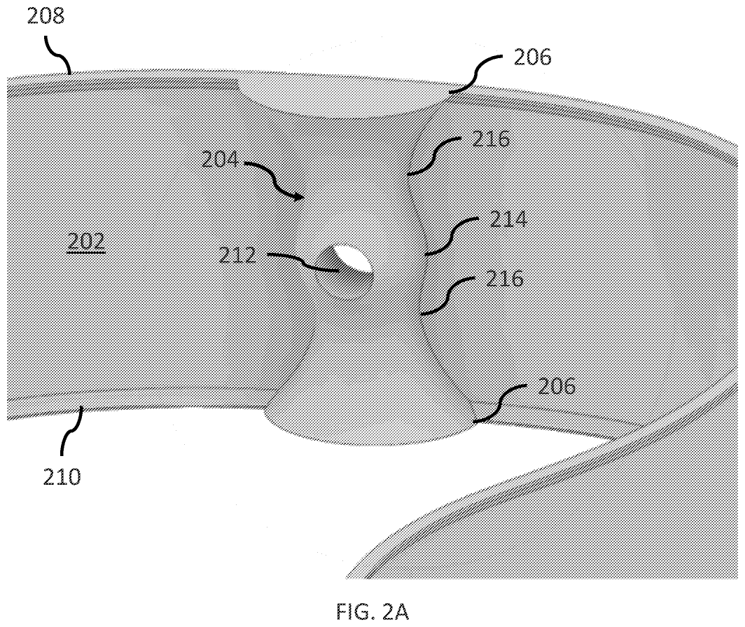

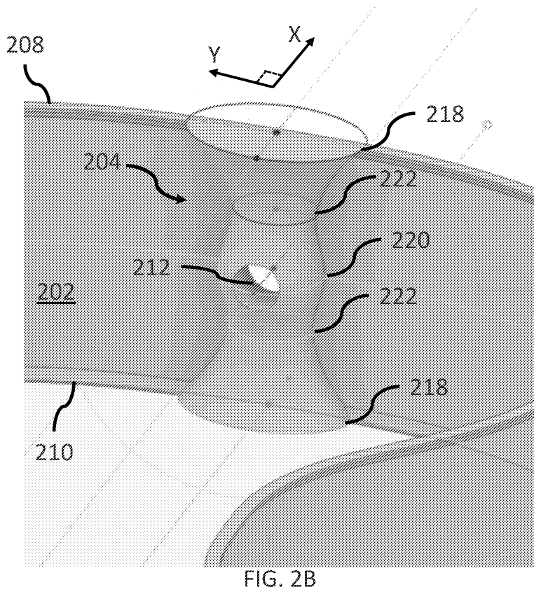

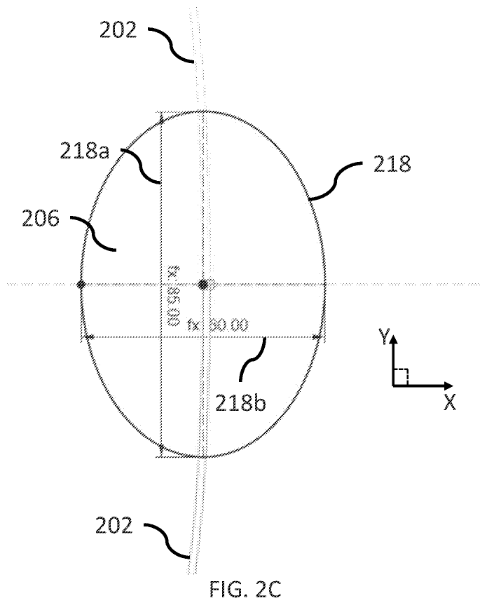

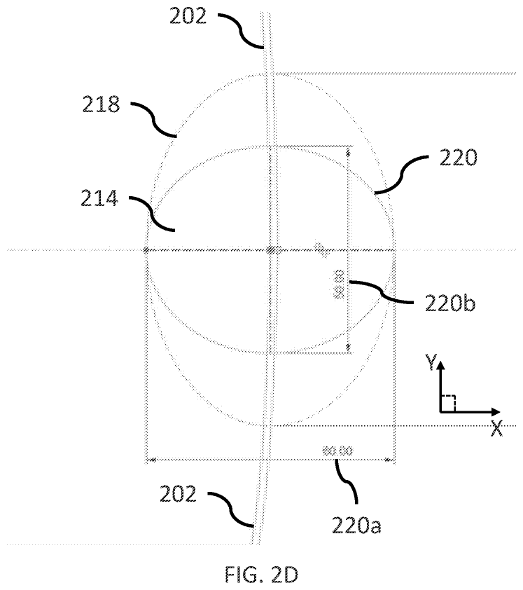

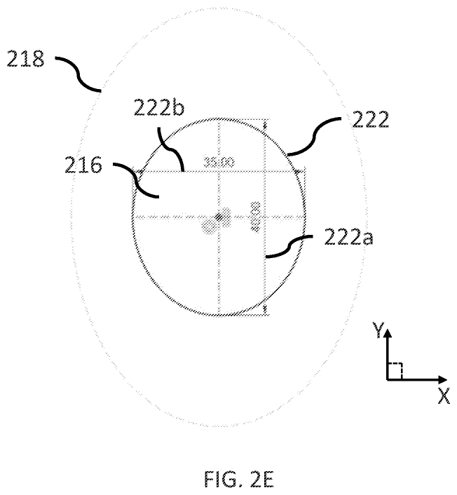

FIG. 2A is a perspective view of a portion of the ribs 202 of a cello having a curvilinear bottom block 204 according to one embodiment of the disclosure. In this embodiment, the bottom block 204 has its largest transverse cross-sections 206 at the top rim 208 and the back rim 210 of the ribs 202. Midway between the top rim 208 and the back rim 210, where the endpin hole 212 is located, the bottom block 204 has an intermediate-sized, middle transverse cross-section 214. Approximately midway between the middle cross-section 214 and each largest cross-section 206, the bottom block 204 has its smallest transverse cross-sections 216. In this embodiment, the bottom block 204 could be referred to as having a “double hourglass” shape consisting of (i) a top hourglass shape from the top rim 208 to the middle of the endpin hole 212 on top of (ii) a back hourglass shape from the middle of the endpin hole 212 to the back rim 210.

FIG. 2B is a perspective view of the same portion of the ribs 202 as shown in FIG. 2A depicted with the full ellipses 218, 220, and 222 that define the partial-elliptical shapes of the transverse cross-sections 206, 214, and 216, respectively, of the bottom block 204.

FIG. 2C is a plan view of the full ellipse 218 that defines the largest transverse cross-sections 206 of the bottom block 204. As shown in FIG. 2C, the full ellipse 218 has a major axis 218a of approximately 85 mm and a minor axis 218b of approximately 60 mm.

FIG. 2D is a plan view of the full ellipse 220 that defines the middle transverse cross-section 214 of the bottom block 204. As shown in FIG. 2D, the full ellipse 220 has a major axis 220a of approximately 60 mm and a minor axis 220b of approximately 50 mm.

FIG. 2E is a plan view of the full ellipse 222 that defines the smallest transverse cross-sections 216 of the bottom block 204. As shown in FIG. 2E, the full ellipse 222 has a major axis 222a of approximately 40 mm and a minor axis 222b of approximately 35 mm.

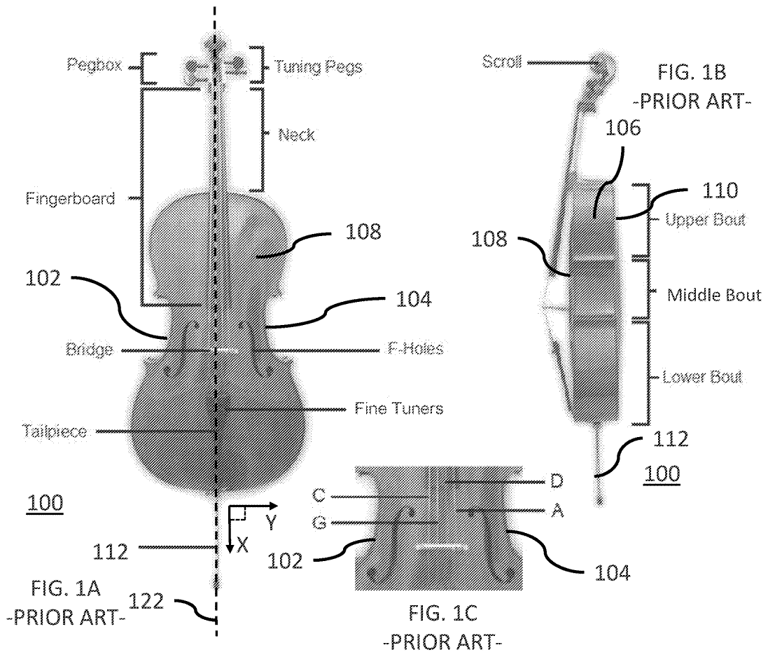

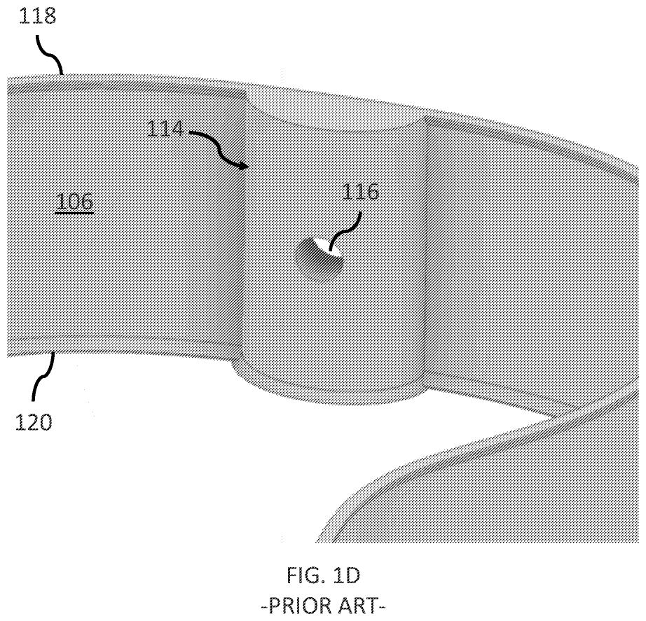

As indicated in FIGS. 2C and 2E, the major axes 218a and 222a of the full ellipses 218 and 222 of the largest and smallest transverse cross-sections 206 and 216 are parallel to the Y direction of FIGS. 1A and 2B, while the minor axes 218b and 222b of those full ellipses 218 and 222 are parallel to the X direction of FIGS. 1A and 2B, where (i) the X direction is parallel to longitudinal axis of the tailpin of the cello (see tailpin 112 of FIG. 1A), which X direction may be referred to as the longitudinal axis of the cello itself, and (ii) the Y direction is perpendicular to the bisecting plane of the cello (see bisecting plane 122 of FIG. 1A), where the X direction lies within that bisecting plane. Note, however, that, as indicated in FIG. 2D, the major axis 220a of the full ellipse 220 of the middle transverse cross-section 214 is parallel to the X direction of FIG. 2B, while the minor axis 220b of that full ellipse 220 is parallel to the Y direction of FIG. 2B.

Note the curvature of the ribs 202 shown in FIGS. 2C and 2D, where the left side of the figures correspond to the interior of the cello body.

Compared to the shape of a conventional, uniform bottom block, curvilinear bottom blocks of the disclosure may have one or more of the following advantages:
Reduced mass of bottom block;
Reduced wolf tones of resulting cello;
Easier to fabricate using 3D printing; and
Improved sound of the resulting cello.

### Asymmetry

Referring again to FIG. 1A, the dashed line 122 represents an imaginary plane, perpendicular to the page in FIG. 1A, that bisects the cello 100 into its C-string side 102 and its A-string side 104. In the cello 100, the top 108 and back 110 of the cello 100 are symmetric about that bisecting plane 122 and have identical top-down profiles in the view of FIG. 1A. In other words, at any point along the centerline 122 from the top of the upper bout (i.e., where the upper bout meets the neck) to the bottom of the lower bout (i.e., where the lower bout meets the tail spike), the following four distances are substantially identical:
The perpendicular distance from the bisecting plane 122 to the outer edge of the top 108 on the C-string side 102;
The perpendicular distance from the bisecting plane 122 to the outer edge of the top 108 on the A-string side 104;
The perpendicular distance from the bisecting plane 122 to the outer edge of the back 110 on the C-string side 102; and
The perpendicular distance from the bisecting plane 122 to the outer edge of the back 110 on the A-string side 104.
   The first two bullets imply that the top 108 has left-right symmetry (i.e., the C-string side 102 of the top 108 is a mirror image of the A-string side 104 of the top 108), while the last two bullets imply that the back 110 has left-right symmetry (i.e., the C-string side 102 of the back 110 is a mirror image of the A-string side 104 of the back 110).

In addition, the ribs 106, which also have left-right symmetry, meet the top 108 and back 110 at the outer edges of their identical profiles. In other words, the top-down profile of the ribs 106 is identical to the top-down profiles of the top 108 and back 110. As such, in the view of FIG. 1A, the ribs 106 are vertical (i.e., perpendicular to the page in FIG. 1A).

Conventional stringed instruments, such as violins, violas, cellos, and double basses, all have these internal symmetries and relationships.

According to certain embodiments of the present disclosure, stringed instruments, such as violins, violas, cellos, and double basses, do not have the same internal symmetries and relationships that conventional stringed instruments have. For example, in some embodiments of the disclosure, while the top has left-right symmetry and the middle and lower bouts of the back have left-right symmetry, the upper bout of the back does not have left-right symmetry. Instead, the upper bout of the back has left-right asymmetry. In particular, the upper bout of the back is chased in such that the perpendicular distance from the bisecting plane to the outer edge of the back on the C-string side is shorter than the distance from the bisecting plane to the outer edge of the back on A-string side, with the left-right difference between those distances increasing from zero at the top of the upper bout (where the upper bout meets the neck) to a maximum left-right difference at the center of the upper bout and then decreasing again to zero at the bottom of the upper bout (where the upper bout meets the middle bout). In a cello of the present disclosure, the maximum left-right difference at the center of the upper bout of the back is about 10 mm+/−2 mm.

In addition, in a cello of the present disclosure, the top overhangs the ribs by about 4 mm+/−1 mm, and the back “underhangs” the ribs by about 1.5 mm+/−0.5 mm. That is, the top-down profile of the top is larger than the profile of the ribs by about 4 mm where the top meets the ribs, and the top-down profile of the back is larger than the profile of the ribs by about 1.5 mm where the back meets the ribs.

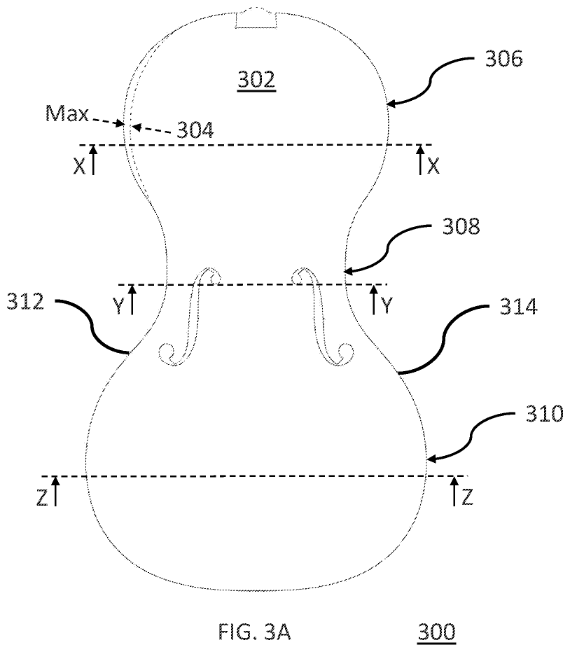

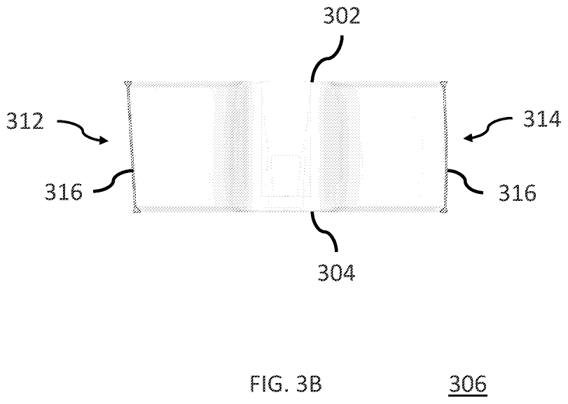

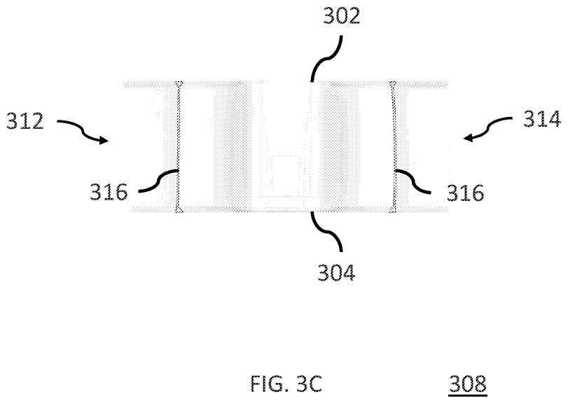

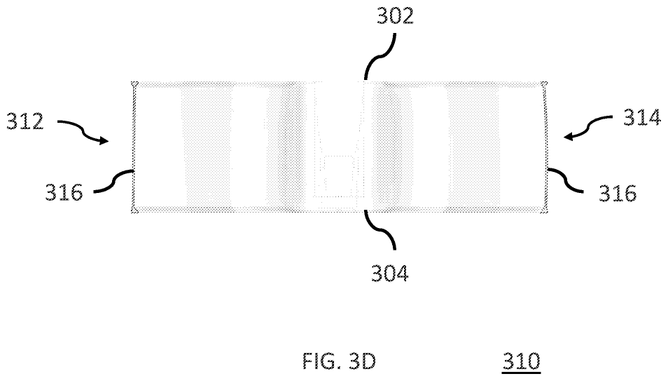

FIG. 3A shows a top-down view of the top 302 of a cello 300 according to certain embodiments of the disclosure superimposed over the back 304 of the cello 300, where the outline of the top 302 is represented by a solid line and the outline of the back 304 is represented by a dashed line. As shown in FIG. 3A, at the middle and lower bouts 308 and 310, the outer edge of the top-down profile of the top 302 substantially coincides with the outer edge of the top-down profile of the back 304. The same is true on the A-string side 314 of the upper bout 306. However, on the C-string side 312 of the upper bout 306, the outer edge of the upper bout 306 of the back 304 is gradually chased in towards the center of the upper bout 306 up to about 10 mm+/−2 mm corresponding to the left-right asymmetry of the upper bout 306 of the back 304.

In addition, in a cello of the present disclosure, on the C-string side, the ribs connect the top and the back in a straight shot, such that, on the C-string side, the shape of the ribs from any point where the ribs meet the top to the corresponding point where the ribs meet the back is linear. Due to the left-right asymmetry of the upper bout of the back of the cello, the ribs on the C-string side of the upper bout are not vertical, but are instead tilted at varying angles relative to vertical corresponding to the varying left-right asymmetry of the upper bout of the back. On the other hand, the ribs on the C-string side of the middle and lower bouts are vertical as in a conventional cello.

In addition, in a cello of the present disclosure, on the A-string side, the ribs at the upper, middle, and lower bouts are bowed out like the staves of a barrel, thereby giving the ribs a convex shape on the A-string side of the cello. In some implementations, the magnitude of the bowing on the A-string side is such that the middle of the ribs (i.e., midway between the top and back) bows out about 4 mm+/−2 mm beyond where the ribs meet the top and where the ribs meet the back. This bowing results in an increase in the internal volume of the cello on the A-string side that compensates for the decrease in the internal volume that results from the left-right asymmetry at the upper bout of the back. It has also been noted that increasing the internal volume on the A-string side of the ribs provides additional lower-mid open G string resonance and volume.

FIGS. 3B-3D show respective cross-sectional views of the centers of the upper bout 306 (view X-X of FIG. 3A), the middle bout 308 (view Y-Y of FIG. 3A), and the lower bout 310 (view Z-Z of FIG. 3A) of the cello 300 of FIG. 3A. As shown in FIG. 3B, the ribs 316 at the center of the C-string side 312 of the upper bout 306 are straight, but tilted, while the ribs 316 at the centers of the C-string side 312 of the middle and lower bouts 308 and 310 are straight and vertical as shown in FIGS. 3C and 3D, respectively. As shown in FIGS. 3B-3D, the ribs 316 at the A-string side 314 of the upper, middle, and lower bouts 306, 308, and 310, respectively, are all bowed outward.

In some implementations, the top 302 and back 304 of the cello 300 are both custom made from carbon fiber sheets using computer numerical control (CNC) manufacturing at the XC Carbon Fiber Company in China (https://www.xccarbonfiber.com/), where the top 302 is preferably between 1 mm and 2 mm thick and the back 304 is preferably between 0.5 mm and 2 mm thick. In alternative implementations, the top 302 and/or the back 304 may be 3D printed using polycarbonate carbon fiber-infused filament (CF). Alternatively, wood or a suitable plastic may be used for the top 302 and/or the back 304 utilizing other suitable manufacturing techniques.

Carbon fiber-infused filament may be used to increase the specific modulus of certain parts (e.g., the ribs, the heel, the neck, and the scroll). Additionally, the ribs 316 may be 3D printed in an efficient pattern using a single extrusion of plastic for each rib wall layer. The ribs 316 may be 3D printed as if the cello 300 were lying down with its back 304 against the print bed, forming the height of the ribs 316 with each successive layer. The rib height of a traditional cello is about 12 cm. In certain implementations of the present disclosure, the height of the ribs 316 is about 14.5 cm in order to give the bridge approximately the same height as a traditional cello (taking into account the eventual concavity of the top 302 and the eventual convexity of the back 304), while also maintaining a similar total volume of air in the body of the instrument (i.e., the volume formed by the top 302, back 304, and ribs 316).

In violins, violas, and double basses according to certain embodiments of the present disclosure, the magnitudes of the asymmetries described above are scaled according to the different overall sizes of those instruments. For example, since violins and violas are smaller than cellos, the maximum left-right differences at the centers of the upper bouts of their backs will be correspondingly smaller than the approximately 10-mm maximum left-right difference at the center of the upper bout 306 of the back 304 of the cello 300, while the maximum left-right difference at the center of the upper bout of the back of a double bass will be correspondingly larger than the approximately 10-mm maximum left-right difference at the center of the upper bout 306 of the back 304 of the cello 300 due to double basses being larger than cellos.

### Adjustable Neck

The '743 application describes particular designs for enabling a stringed instrument to have an adjustable neck. The present disclosure includes different designs for enabling a stringed instrument to have an adjustable neck.

According to certain embodiments of the present disclosure, during manufacturing, a hole is formed all the way through the heel of the scroll from the top side of the heel to the back side of the heel. In some implementations in which the heel is 3D printed, the hole is formed as part of the 3D printing process. In other implementations, the heel is 3D printed without the hole, which is formed by drilling the heel after the 3D printing process. Similarly, the top block of the ribs also has a corresponding hole through it on the back of the top block.

In some implementations, a metal, hex-drive, threaded wood insert is then rotated into the hole in the heel from the top side of the hole using an Allen wrench, thereby securing the insert inside the heel. In some implementations, the insert is a Zinc-Plated Steel Tapping Insert for Hardwood, ¼″-20 Thread Size, 0.472″ Installed Length, available from McMaster-Carr of Douglasville, Georgia.

The heel-neck-and-scroll subassembly is then mated with the top-ribs-and-back subassembly using a screw that is inserted through the hole in the top block of the ribs and into the back side of the hole in the heel and then rotated to engage the inner threads of the embedded insert in the heel. The screw can be rotated one way or the other to move the heel-neck-and-scroll subassembly farther away from or closer to the strings to achieve different string heights above the fingerboard, as described in the '743 application.

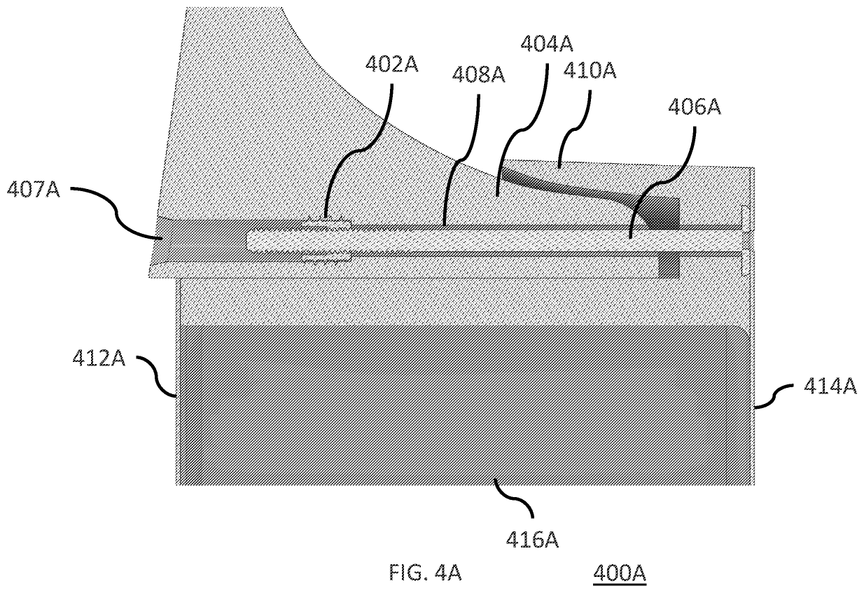

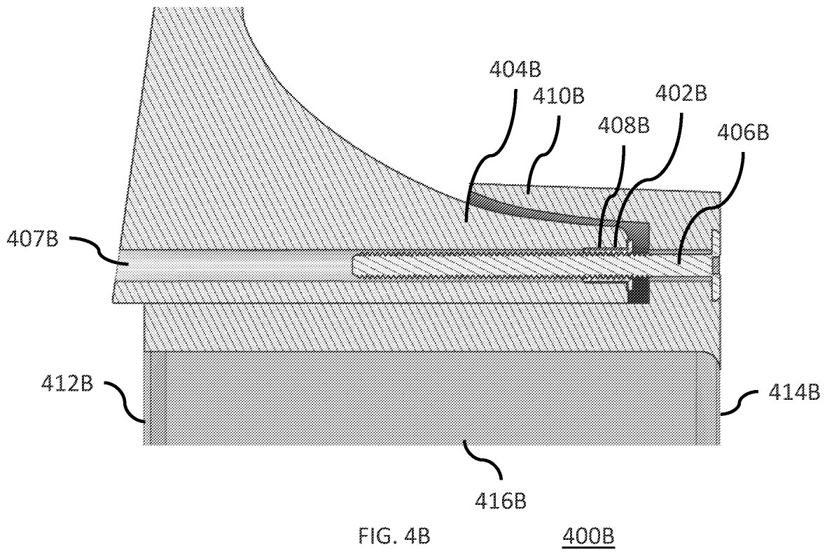

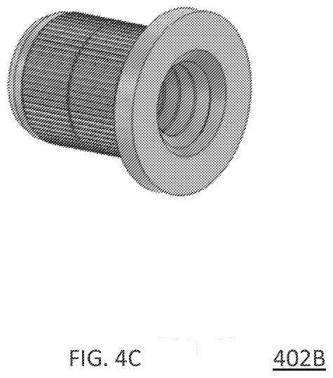

FIG. 4A is a partial, cross-sectional, side view of a cello 400A of the present disclosure showing (i) an insert 402A embedded in the heel 404A and (ii) a screw 406A engaging the insert 402A to connect the two sub-assemblies. As shown in FIG. 4A, the hole through the heel 404A has a larger-diameter wide portion 407A at the top (412A) side of the heel 404A and a smaller-diameter narrow portion 408A at the back (414A) side of the heel 404A, with the insert 402A mounted within the wide portion 407A up to the shoulder formed at the transition from the wide portion 407A to the narrow portion 408A. The wide portion 407A of the hole in the heel 404A is sized such that the outer threading of the insert 402A cuts into the neck material, thereby securing the insert 402A in place, while the narrow portion 408A of the hole in the heel 404A and the hole in the top block 410A of the ribs 416A are sized to receive the screw 406A.

In other implementations, a metal insert is forced into the hole in the heel from the back side of the hole, thereby securing the insert inside the heel. In some implementations, the insert is a Zinc-Plated Steel Knurled Insert for Hardwood, ¼″-20 Thread Size, 0.473″ Installed Length, available from McMaster-Carr of Douglasville, Georgia.

As before, the heel-neck-and-scroll subassembly is then mated with the top-ribs-and-back subassembly using a screw that is inserted through the hole in the top block of the ribs and into the back side of the hole in the heel and then rotated to engage the inner threads of the embedded insert in the heel. The screw can be rotated one way or the other to move the heel-neck-and-scroll subassembly farther away from or closer to the strings to achieve different string heights above the fingerboard, as described in the '743 application.

FIG. 4B is a partial, cross-sectional, side view of a cello 400B of the present disclosure showing (i) an insert 402B embedded in the heel 404B and (ii) a screw 406B engaging the insert 402B to connect the two sub-assemblies. As shown in FIG. 4B, the hole through the heel 404B has a smaller-diameter narrow portion 407B at the top (412B) side of the heel 404B and a larger-diameter wide portion 408B at the back (414B) side of the heel 404B, with the insert 402B mounted within the wide portion 408B up to the shoulder formed at the transition from the narrow portion 407B to the wide portion 408B. The wide portion 408B of the hole in the heel 404B is sized such that the outer knurling of the insert 402B cuts into the neck material, thereby securing the insert 402B in place, while the narrow portion 407B of the hole in the heel 404B and the hole in the top block 410B of the ribs 416B are sized to receive the screw 406B.

FIG. 4C is a perspective view of the insert 402B of FIG. 4B.

Although the disclosure has been described in the context of cellos, those skilled in the art will understand that embodiments of the present disclosure can be implemented in the context of any stringed instrument having a soundpost, such as (without limitation) violins, violas, and double basses. In addition, certain embodiments of the present disclosure, e.g., those having adjustable necks, can also be implemented in the context of stringed instruments that do not have soundposts, such as (without limitation) guitars.

Note that the feature of an adjustable neck may be applied to any suitable stringed instrument with or without the asymmetries described above. Similarly, stringed instruments with the asymmetries described above can be implemented with or without an adjustable neck.

### Wolf Stopper

According to certain embodiments of the present disclosure, stringed instruments, such as violins, violas, cellos, and double basses, are configured with one or more wolf stoppers to reduce or even eliminate wolf tones.

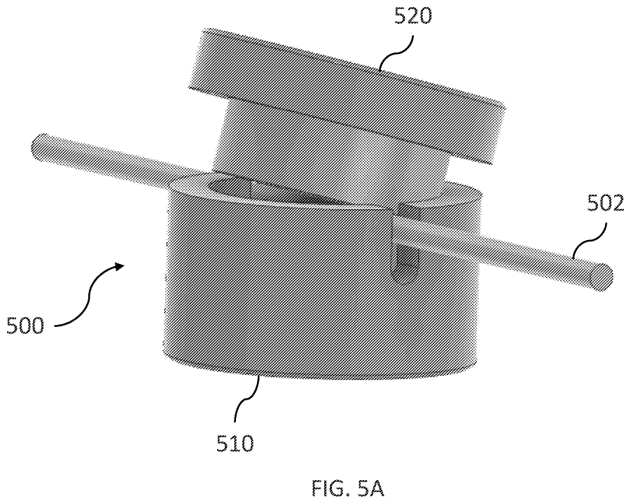

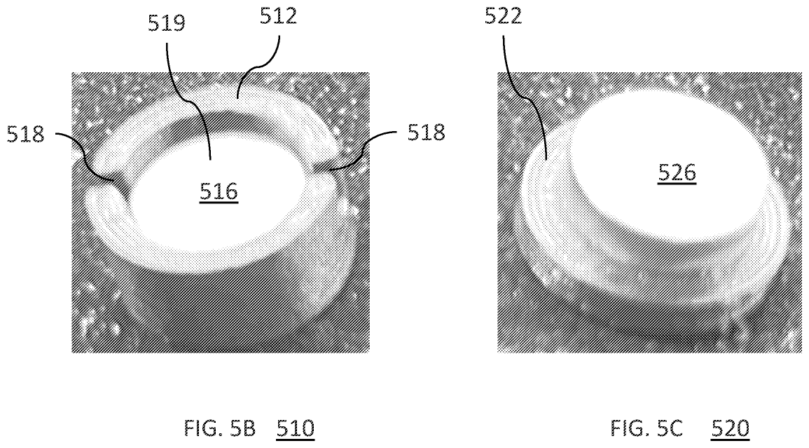

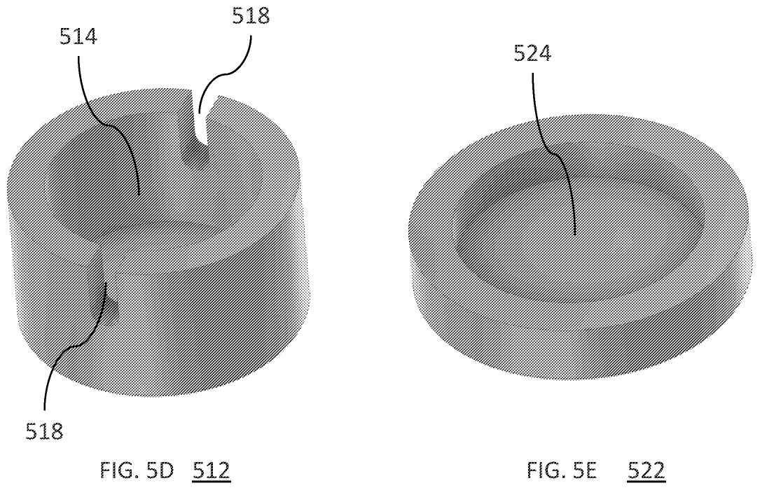

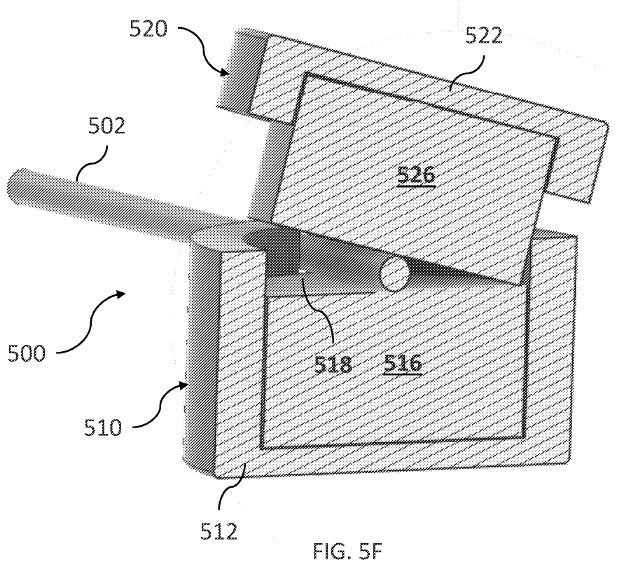

FIG. 5A is perspective view showing a two-piece wolf stopper 500, according to one embodiment of the disclosure, mounted onto a string 502 of a cello, for example, between the bridge and the tailpiece of the cello, in a so-called tilted configuration. As shown in FIG. 5A, the two-piece wolf stopper 500 has a base assembly 510 and a cap assembly 520. FIGS. 5B and 5C are respective perspective views of the base assembly 510 and the cap assembly 520 of the two-piece wolf stopper 500 of FIG. 5A. FIGS. 5D and 5E are respective perspective views of the base 512 and the cap 522 of the base and cap assemblies 510 and 520 of FIGS. 5B and 5C.

The base assembly 510 consists of a cylindrical base 512 having a cylindrical opening 514 for receiving a cylindrical base magnet 516 and two opposing sidewall slots 518 for receiving a cello string. Similarly, the cap assembly 520 consists of a cylindrical cap 522 having cylindrical opening 524 for receiving a cylindrical cap magnet 526.

In one possible implementation:
The base 512 and the cap 522 both have outer diameters of 13.5 mm and inner diameters of 10 mm;
The base 512 has a height of 7.4 mm, where the depth of the base opening 514 is 6.3 mm;
The cap 522 has a height of 2.7 mm, where the depth of the cap opening 524 is 1.75 mm;
Each slot 518 in the base 512 has (i) a rectilinear top section having a width of 1.4 mm and a depth of 2.7 mm and (ii) a semi-circular bottom section having a radius of 0.7 mm, such that the total depth of each slot 518 is 3.4 mm;
The base and cap magnets 516 and 526 both have heights of 5 mm and diameters of 10 mm.

As such, when the base magnet 516 (having a height of 5 mm) is mounted within the base opening 514 (having a depth of 6.3 mm), the top of the base magnet 516 is higher than the bottoms of the 3.4-mm slots 518, leaving a recess 519 in the base assembly 510 having a depth of 1.3 mm, as shown in FIG. 5B, to ensure that a received string directly contacts the base magnet 516. When the cap magnet 526 (having a height of 5 mm) is mounted within the cap opening 524 (having a depth of 1.8 mm), the top of the cap magnet 526 extends beyond the top of the cap 522 by 3.25 mm, as shown in FIG. 5C, to ensure that the received string directly contacts the cap magnet 526.

FIG. 5F shows a cross-sectional view of the wolf stopper 500 configured in the tilted configuration of FIG. 5A, with the cello string 502 held in place between the base assembly 510 and the cap assembly 520. As shown in FIG. 5F, in this tilted configuration, the base magnet 516 and the cap magnet 526 are both in direct physical contact with the string 502. In addition, due to the angular orientation of the cap assembly 520 with respect to the base assembly 510, the base magnet 516 is also in direct physical contact with the cap magnet 526. Note that the base magnet 516 and the cap magnet 526 are respectively oriented within the base 512 and the cap 522 such that there is an attractive magnetic force applied between the two magnets 516 and 526 in the tilted configuration of FIGS. 5A and 5F with the direct physical contact between the two magnets 516 and 526 resulting in an increased net attractive magnetic force compared to a non-tilted configuration in which the two magnets 516 and 526 directly contact only the string 502 and not each other. In the tilted configuration, the resultant attractive magnetic force between the two magnets 516 and 526 prevents the wolf stopper 500 from internally vibrating when the received cello string 502 is played, which internal vibration could create undesirable extraneous noise.

Cello strings range in diameter from 0.7 mm (and possibly smaller) for the highest pitch (i.e., A) strings up to 1.6 mm (and possibly larger) for the lowest pitch (i.e., C) strings. The dimensions of the components described above enable the wolf stopper 500 of FIGS. 5A-5F to be mounted in a tilted configuration onto any one of the four typical strings of a cello. In practice, one or more wolf stoppers 500 may be simultaneously mounted onto one or more strings of a cello.

In one possible implementation, the base 512 and cap 522 are manufactured (e.g., by 3D printing or molding) from a suitable material, such as, without limitation, push plastic carbon fiber (polycarbonate+polybutylene terephthalate) (CF PC/PBT) or other suitable plastic, and the base and cap magnets 516 and 526 are neodymium magnets, such as Eokoaiee brand 10×5 mm Decorative Fridge Magnets from Zhong Chan, China, and available at Amazon. com, where the magnets 516 and 526 are respectively glued into the base CC and cap DC using a suitable adhesive, such as cyanoacrylate glue. In that case, the assembled two-piece wolf stopper 500 weighs 6.65 grams. Note that cap magnets 526 with different heights and weights can be used to achieve wolf stoppers 500 having different total weights, as needed to inhibit wolf tones.

Although the present disclosure has been described in the context of the wolf stopper 500 of FIGS. 5A-5F having components with the specific dimensions and compositions described above, those skilled in the art will understand that, in alternative embodiments, wolf stoppers of the present disclosure may have components with different dimensions and/or compositions.

Those skilled in the art will understand that cellos of the present disclosure may have one or more or all of the following features:
A curvilinear bottom block as described above with reference to FIGS. 2A-2E;
An asymmetric back as described above with reference to FIGS. 3A-3D;
An adjustable neck as described above with reference to FIG. 4; and
One or more wolf stoppers as described above with reference to FIGS. 5A-5F.

Although the disclosure has been described in the context of cellos, those skilled in the art will understand that embodiments of the present disclosure can be implemented in the context of any stringed instrument having a soundpost, such as (without limitation) violins, violas, and double basses. In addition, certain embodiments of the present disclosure can also be implemented in the context of stringed instruments that do not have soundposts, such as (without limitation) guitars.

According to certain embodiments, a musical instrument comprises a back separated from a top by a rib structure to define an interior of the instrument, wherein (i) the rib structure has a curvilinear bottom block within the interior of the instrument spanning between a top rim at the top of the instrument and a back rim at the back of the instrument and (ii) the curvilinear bottom block has transverse cross-sections that vary from the top rim to the back rim.

According to at least some of the above embodiments, the curvilinear bottom block comprises relatively large transverse cross-sections at the top and back rims; an intermediate-sized, middle transverse cross-section approximately midway between the top rim and the back rim; and relatively small transverse cross-sections between the middle transverse cross-section and the relatively large transverse cross-sections.

According to at least some of the above embodiments, the curvilinear bottom block has an endpin hole at the intermediate-sized middle transverse cross-section.

According to at least some of the above embodiments, the largest transverse cross-sections have a partial-elliptical shape corresponding to a full ellipse having a major axis perpendicular to a bisecting plane of the instrument and a minor axis parallel to the bisecting plane; the middle transverse cross-section has a partial-elliptical shape corresponding to a full ellipse having a major axis parallel to the bisecting plane and a minor axis perpendicular to the bisecting plane; and the smallest transverse cross-sections have a partial-elliptical shape corresponding to a full ellipse having a major axis perpendicular to the bisecting plane and a minor axis parallel to the bisecting plane.

According to at least some of the above embodiments, the instrument is a cello; for the largest transverse cross-sections, the full ellipse has a major axis of approximately 85 mm and a minor axis of approximately 60 mm; for the middle transverse cross-section, the full ellipse has a major axis of approximately 60 mm and a minor axis of approximately 50 mm; and for the smallest transverse cross-sections, full ellipse has a major axis of approximately 40 mm and a minor axis of approximately 35 mm.

According to at least some of the above embodiments, the curvilinear bottom block has an endpin hole approximately midway between the top rim and the back rim; and the curvilinear bottom block has a double hourglass shape consisting of (i) a top hourglass shape from the top rim to the middle of the endpin hole on top of (ii) a back hourglass shape from the middle of the endpin hole to the back rim.

According to at least some of the above embodiments, the instrument comprises a middle bout between an upper bout and a lower bout, where the back is asymmetric at the upper bout about a center line running from a neck of the instrument to a tail of the instrument.

According to at least some of the above embodiments, at the upper bout, a distance from a C-string side of the instrument to the center line is smaller than a distance from an A-string side of the instrument to the center line.

According to at least some of the above embodiments, at the upper bout, on the C-string side, the rib structure is straight and tilted relative to the back of the instrument and, on the A-string side, the rib structure is bowed outward.

According to at least some of the above embodiments, at the middle and lower bouts, on the C-string side, the rib structure is straight and vertical relative to the back of the instrument and, on the A-string side, the rib structure is bowed outward.

According to at least some of the above embodiments, the instrument comprises an adjustable neck, wherein the neck has a heel hole running through the neck's heel; the heel hole has a wider portion and a narrower portion; a threaded insert is located within the wider portion of the heel hole at a shoulder defined by the wider and narrower portions of the heel hole; the rib structure has a top-block hole running through the rib structure's top block; and the adjustable neck is configured to adjust a distance between the heel and the top block by rotating a screw inserted through the top-block hole and engaging the insert.

According to at least some of the above embodiments, the wider portion of the heel hole is at a top side of the heel, and the narrower portion of the heel hole is at a back side of the heel.

According to at least some of the above embodiments, the wider portion of the heel hole is at a back side of the heel, and the narrower portion of the heel hole is at a top side of the heel.

According to at least some of the above embodiments, the instrument further comprises a wolf stopper comprising (a) a base assembly comprising a base magnet located within a base opening to define a base recess in the base assembly having opposing sidewall slots and (b) a cap assembly comprising a cap magnet located within a cap opening to define a cap extension of the cap assembly, wherein the wolf stopper is configured to be removably connected to a string of the instrument by orienting the base assembly with the string located within the opposing sidewall slots and the cap assembly oriented over the base assembly in a tilted configuration wherein (i) both the base magnet and the cap magnet are in direct with the string and (ii) the base magnet is in direct contact with the cap magnet.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this disclosure may be made by those skilled in the art without departing from embodiments of the disclosure encompassed by the following claims.

In this specification including any claims, the term “each” may be used to refer to one or more specified characteristics of a plurality of previously recited elements or steps.

When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

1-15. (canceled)

16. An apparatus comprising a wolf stopper (e.g., 500) for a stringed instrument, the wolf stopper comprising:
a base assembly (e.g., 510) comprising a base magnet (e.g., 516) located within a base opening (e.g., 514) that defines a base recess (e.g., 519) in the base assembly having opposing sidewall slots (e.g., 518); and
a cap assembly (e.g., 520) comprising a cap magnet (e.g., 526) located within a cap opening (e.g., 524) to define a cap extension of the cap assembly, wherein the wolf stopper is configured to be removably connected to a string (e.g., 502) of the instrument by orienting the base assembly with the string located within the opposing sidewall slots and the cap assembly oriented over the base assembly in a tilted configuration (e.g., FIGS. 5A and 5F) wherein (i) both the base magnet and the cap magnet are in direct with the string and (ii) the base magnet is in direct contact with the cap magnet.

17. The apparatus of claim 16, further comprising the stringed instrument.

18. The apparatus of claim 17, wherein the instrument comprises a back separated from a top by a rib structure to define an interior of the instrument, wherein:
the rib structure has a curvilinear bottom block within the interior of the instrument spanning between a top rim at the top of the instrument and a back rim at the back of the instrument; and
the curvilinear bottom block has transverse cross-sections that vary from the top rim to the back rim.

19. The apparatus of claim 18, wherein the curvilinear bottom block comprises:
relatively large transverse cross-sections at the top and back rims;
an intermediate-sized, middle transverse cross-section approximately midway between the top rim and the back rim; and
relatively small transverse cross-sections between the middle transverse cross-section and the relatively large transverse cross-sections.

20. The apparatus of claim 19, wherein the curvilinear bottom block has an endpin hole at the intermediate-sized middle transverse cross-section.

21. The apparatus of claim 18, wherein:
the largest transverse cross-sections have a partial-elliptical shape corresponding to a full ellipse having a major axis perpendicular to a bisecting plane of the instrument and a minor axis parallel to the bisecting plane;
the middle transverse cross-section has a partial-elliptical shape corresponding to a full ellipse having a major axis parallel to the bisecting plane and a minor axis perpendicular to the bisecting plane; and
the smallest transverse cross-sections have a partial-elliptical shape corresponding to a full ellipse having a major axis perpendicular to the bisecting plane and a minor axis parallel to the bisecting plane.

22. The apparatus of claim 21, wherein:
the instrument is a cello;
for the largest transverse cross-sections, the full ellipse has a major axis of approximately 85 mm and a minor axis of approximately 60 mm;
for the middle transverse cross-section, the full ellipse has a major axis of approximately 60 mm and a minor axis of approximately 50 mm; and
for the smallest transverse cross-sections, full ellipse has a major axis of approximately 40 mm and a minor axis of approximately 35 mm.

23. The apparatus of claim 18, wherein:
the curvilinear bottom block has an endpin hole approximately midway between the top rim and the back rim; and
the curvilinear bottom block has a double hourglass shape consisting of (i) a top hourglass shape from the top rim to the middle of the endpin hole on top of (ii) a back hourglass shape from the middle of the endpin hole to the back rim.

24. The apparatus of claim 17, wherein:
the instrument comprises a middle bout between an upper bout and a lower bout; and
the back is asymmetric at the upper bout about a center line running from a neck of the instrument to a tail of the instrument.

25. The apparatus of claim 24, wherein, at the upper bout, a distance from a C-string side of the instrument to the center line is smaller than a distance from an A-string side of the instrument to the center line.

26. The apparatus of claim 24, wherein, at the upper bout, on the C-string side, the rib structure is straight and tilted relative to the back of the instrument and, on the A-string side, the rib structure is bowed outward.

27. The apparatus of claim 26, wherein, at the middle and lower bouts, on the C-string side, the rib structure is straight and vertical relative to the back of the instrument and, on the A-string side, the rib structure is bowed outward.

28. The apparatus of claim 17, wherein the instrument comprises an adjustable neck, wherein:
the neck has a heel hole running through the neck's heel;
the heel hole has a wider portion and a narrower portion;
a threaded insert is located within the wider portion of the heel hole at a shoulder defined by the wider and narrower portions of the heel hole;
the rib structure has a top-block hole running through the rib structure's top block; and
the adjustable neck is configured to adjust a distance between the heel and the top block by rotating a screw inserted through the top-block hole and engaging the insert.

29. The apparatus of claim 28, wherein:
the wider portion of the heel hole is at a top side of the heel; and
the narrower portion of the heel hole is at a back side of the heel.

30. The apparatus of claim 28, wherein:
the wider portion of the heel hole is at a back side of the heel; and
the narrower portion of the heel hole is at a top side of the heel.

31. A method for inhibiting wolf tones in a stringed instrument, the method comprising:
orienting a base assembly of a wolf stopper such that a string of the instrument is located within opposing sidewall slots of the base assembly; and
orienting a cap assembly of the wolf stopper over the base assembly in a tilted configuration (e.g., FIGS. 5A and 5F) wherein (i) both a base magnet of the base assembly and a cap magnet of the cap assembly are in direct with the string and (ii) the base magnet is in direct contact with the cap magnet, wherein:
the base assembly (e.g., 510) comprises the base magnet (e.g., 516) located within a base opening (e.g., 514) that defines a base recess (e.g., 519) in the base assembly having the opposing sidewall slots (e.g., 518); and
the cap assembly (e.g., 520) comprises the cap magnet (e.g., 526) located within a cap opening (e.g., 524) to define a cap extension of the cap assembly.
